(19) United States
(12) Patent Application Publication
(10) Pub. No.: US 2014/0302894 A1
(43) Pub. Date: Oct. 9, 2014

(54) Method and Apparatus for Determining Whether Ear of User is Contiguous to Electronic Device or Whether User Watches Display of Electronic Device

(71) Applicant: FRASEN INC., Daejeon (KR)

(72) Inventors: Hyo Jun Woo, Daejeon (KR); Hyo Min Woo, Daejeon (KR)

(73) Assignee: FRASEN INC., Daejeon (KR)

(21) Appl. No.: 14/154,062

(22) Filed: Jan. 13, 2014

(30) Foreign Application Priority Data
Apr. 8, 2013 (KR) 10-2013-0037869
Aug. 7, 2013 (KR) 10-2013-0093870

(51) Int. Cl. H04W 52/02

(52) U.S. Cl. CPC H04W 52/0254
USPC 455/566

(57) ABSTRACT

A method and apparatus for determining whether a ear of a user is contiguous to an electronic device or whether a user watches a display of the electronic device are disclosed herein. The method for determining a proximity level between an electronic device and a user includes the steps of acquiring a measurement value from at least one sensor being differentiated from a proximity sensor, detecting a movement of the electronic device by using the measurement value, responding to the detection of the electronic device and determining whether or not the electronic device is placed near (or contiguous to) the user or whether or not the user is viewing a display of the electronic device by using the measurement value, and controlling the electronic device based upon the determined result. Accordingly, the proximity level between the electronic device and the user may be determined without having to use a proximity sensor.

This application claims the benefit of the Korean Patent Application No. 10-2013-0093870, filed on Aug. 07, 2013 and Korean Patent Application No. 10-2013-0037869, filed on Apr. 08, 2013, which are hereby incorporated by reference as if fully set forth herein.

### BACKGROUND OF THE INVENTION

1. Field of the Invention

The following exemplary embodiments of the present invention respectively relate to a method and apparatus for determining whether a ear of a user is contiguous to (or placed near) an electronic device or whether a user watches a display of the electronic device.

2. Discussion of the Related Art

Electronic devices may include various types of sensors. Most particularly, mobile devices, such as mobile phones, smart phones, tablet personal computers (PCs), and notebook (or laptop) computers, include gravity sensors, acceleration sensors, gyro sensors, global positioning system (GPS) sensors, direction sensors, audio sensors (microphones), optical sensors, thermal sensors, humidity sensors, altitude sensors, orientation sensors, rotation sensors, vision sensors, touch sensors, and so on.

Most particularly, recent mobile phones (or smart phones) support phone call functions, and the user places his (or her) mobile phone near his (or her) ear while making a phone call. At this point, in case the user's ear and the mobile phone are contiguous (or placed near one another) during a phone call, since the user is not watching a display of the mobile phone, in order to reduce excessive power consumption, or in order to prevent unwanted operation from occurring due to an unintended touch, the power being supplied to the display is blocked or reduced. Additionally, in case the user's ear and the mobile phone are spaced apart from one another during the phone call, this may indicate that the user wishes to manipulate his (or her) mobile phone. Therefore, the power being supplied to the display is increased or maintained. For example, if the mobile phone is placed further away from the user's ear, the display that was turned off may be turned back on.

Whether or not the mobile phone is contiguous to (or placed near) the user's ear is determined by a proximity sensor. More specifically, the proximity sensor measures a proximity level between the user's ear and the user's mobile phone. Then, the proximity sensor may determine whether or not the mobile phone is contiguous to (or placed near) the user's ear based upon the measured proximity level. Due to such proximity sensors, excessive power consumption of the mobile phone may be reduced, and malfunction occurring due to an unintended touch may be prevented.

However, the proximity sensor that is being included in the mobile phone is not frequently used for purposes other than the above-described purpose. Most particularly, the proximity sensor is one of many factors for increasing the fabrication cost of the mobile phone and is also one of many factors for increasing the size of the mobile phone. Furthermore, when a malfunction occurs in the proximity sensors, or when a failure (or breakdown) occurs in the proximity sensor, the cost required for repairing or replacing the proximity sensor may become of a large burden to the consumer.

Accordingly, if the main functions of the proximity sensor (i.e., reducing power consumption of the mobile phone or preventing malfunction caused by unintended touch) can be replaced by other sensors or an additional algorithm, the fabrication cost of the mobile phone, the size of the mobile phone, repair and replacement costs may be reduced.

### SUMMARY OF THE INVENTION

Accordingly, the present invention is directed to a method and apparatus for determining whether a ear of a user is contiguous to an electronic device or whether a user watches a display of the electronic device that substantially obviate one or more problems due to limitations and disadvantages of the related art.

An object of the present invention is to provide a method and apparatus for determining whether a ear of a user is contiguous to an electronic device or whether a user watches a display of the electronic device that can reduce the fabrication cost of the mobile phone, the size of the mobile phone, repair and replacement costs by providing the main functions of the proximity sensor without the actual proximity sensor.

Another object of the present invention is to provide a method and apparatus for determining whether a ear of a user is contiguous to an electronic device or whether a user watches a display of the electronic device that can use measurement values of other sensors in order to provide the main functions of the proximity sensor without the actual proximity sensor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to an exemplary embodiment of the present invention, a method for determining a proximity level between an electronic device and a user includes the steps of acquiring a measurement value from at least one sensor being differentiated from a proximity sensor, detecting a movement of the electronic device by using the measurement value, responding to the detection of the electronic device and determining whether or not the electronic device is placed near (or contiguous to) the user or whether or not the user is viewing a display of the electronic device by using the measurement value, and controlling the electronic device based upon the determined result.

The step of controlling the electronic device may include the steps of checking whether or not the electronic device is in a user busy mode, and, in case the electronic device is in the user busy mode, controlling power being supplied to a display of the electronic device based upon the determined result.

The step of determining whether or not the electronic device is placed near the user may correspond to a step of determining whether or not the electronic device is placed near the user or whether or not the user is viewing the display of the electronic device based upon a variation pattern of the measurement values.

The step of determining whether or not the electronic device is placed near the user may include the step of comparing a value indicating a variation pattern of the measurement values with a predetermined threshold value.

The step of determining whether or not the electronic device is placed near the user may correspond to a step of determining whether or not the electronic device is placed near the user or whether or not the user is viewing the display of the electronic device by using measurement values measured by at least two or more sensors, each being differentiated from the proximity sensor and each being different from one another.

In the step of controlling power being supplied to a display of the electronic device, when it is determined that the electronic device is placed near the user, the power being supplied to the display may be reduced or blocked, and, when it is determined that the electronic device is not placed near the user, the power being supplied to the display may be maintained or increased.

The at least one sensor may include at least one of a gyro sensor, a magnetic field sensor, a gravity sensor, an orientation sensor, a rotation sensor, a vision sensor, a thermal sensor, a microphone, an optical sensor, and a touch sensor.

A program for executing the method of the present invention may be stored in a computer-readable recording medium.

According to another exemplary embodiment of the present invention, an electronic device includes a display configured to display an image signal, at least one sensor configured to be differentiated from a proximity sensor and to generate measurement values from a position, alignment or movement of the electronic device, and a processor configured to detect a movement of the electronic device by using the measurement value, to respond to the detection of the electronic device and to determine whether or not the electronic device is placed near the user or whether or not the user is viewing a display of the electronic device by using the measurement value, and to control the electronic device based upon the determined result.

The processor may check whether or not the electronic device is in a user busy mode, and, in case the electronic device is in the user busy mode, the processor may control power being supplied to a display of the electronic device based upon the determined result.

The processor may determine whether or not the electronic device is placed near the user based upon a variation pattern of the measurement values.

The processor may compare a value indicating a variation pattern of the measurement values with a predetermined threshold value.

The processor may determine whether or not the electronic device is placed near the user or whether or not the user is viewing the display of the electronic device by using measurement values measured by at least two or more sensors, wherein each sensor is differentiated from the proximity sensor, and wherein each sensor is different from one another.

When it is determined that the electronic device is placed near the user, the processor may reduce or block the power being supplied to the display, and when it is determined that the electronic device is not placed near the user, the processor may maintain or increase the power being supplied to the display.

The at least one sensor may include at least one of a gyro sensor, a magnetic field sensor, a gravity sensor, an orientation sensor, a rotation sensor, a vision sensor, a thermal sensor, a microphone, an optical sensor, and a touch sensor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates available positions of a user and an electronic device (e.g., mobile phone);

FIG. 2 illustrates a coordinate system respective to a mobile phone;

FIG. 3 illustrates a graph showing measurement values measured from at least one sensor and threshold values;

FIG. 4 illustrates a case when the user's ear is contiguous to (or placed near) the mobile phone or a case when the user is viewing a display of the mobile phone;

FIG. 5 illustrates two different cases when the user can view the mobile phone;

FIG. 6 illustrates a block view showing an electronic device according to an exemplary embodiment of the present invention; and

FIG. 7 illustrates a flow chart showing a method according to an exemplary embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

As described above, according to the exemplary embodiments of the present invention, in order to reduce power being excessively used (or consumed) during a phone call, or in order to prevent any malfunction from occurring due to an unintended touch motion, which is performed during a phone call, measurement values of other sensors may be used instead of those of the proximity sensor. Therefore, the proximity sensor may be removed from the electronic device, and, according to the exemplary embodiment of the present invention, by removing the proximity sensor, the cost of the electronic device may be reduced, or various advantages may be gained during the process of fabricating the electronic device or during the process of having the user repair (or fix) and replace the electronic device.

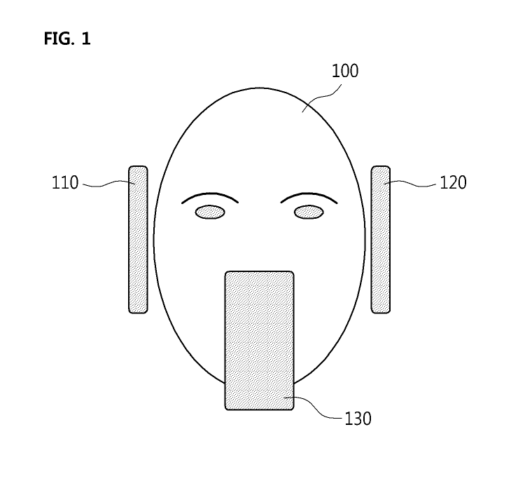

FIG. 1 illustrates available positions of a user and an electronic device (e.g., mobile phone).

Referring to FIG. 1, when a user 100 is sending a phone call or receiving a phone call by using an electronic device, the electronic device 110 may be placed near (or be contiguous to) a right ear of the user 100, or the electronic device 120 may be placed near (or be contiguous to) a left ear of the user 100. Additionally, in case the user 100 is viewing (or watching) a display of the electronic device, the electronic device 130 may be placed (or positioned) in front of a face of the user 100.

During the phone call, the user 100 approaches the electronic device near his (or her) right ear or left ear. At this point, while the user 100 is carrying out the phone call, if the user wishes to perform any maneuver on the electronic device, or if the user wishes to view (or watch) a display of the electronic device, the user 100 shifts the position of the electronic device from his (or her) right ear or left ear to the front of his (or her) face. When the position of the electronic device is shifted from the user's right ear or left ear to the front of the user's face, the display of the electronic device, which was turned off, is automatically turned on. Evidently, in case the display of the electronic device corresponds to a touch display, a deactivated touch sensor may be reactivated.

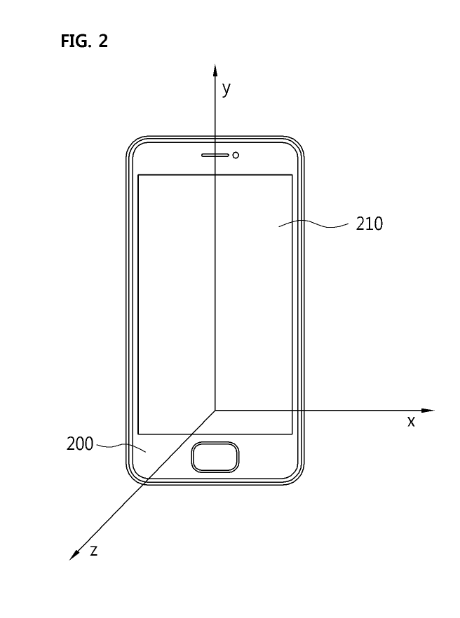

FIG. 2 illustrates a coordinate system respective to a mobile phone.

Hereinafter, for simplicity in the description of the present invention, the coordinate system respective to the electronic device 200 (e.g., mobile phone) will be defined with reference to FIG. 2. The electronic device 200 includes a display 210, and movements of the electronic device 200 may be defined by a combination of linear movements along an x-axis, a y-axis, and a z-axis and rotational movements with respect to the x-axis, the y-axis, and the z-axis. The x-axis, the y-axis, and the z-axis, which will be mentioned in the following description, will be defined in accordance with the coordinate system shown in FIG. 2.

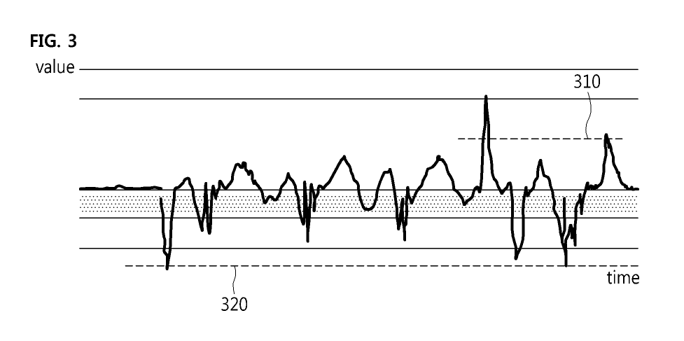

FIG. 3 illustrates a graph showing measurement values measured from at least one sensor and threshold values.

As described above, the exemplary embodiments of the present invention may determine whether the user's ear is positioned near (or contiguous to) the electronic device or whether the user is viewing the display of the electronic device by using measurement values of other sensors installed in the electronic device, instead of using measurement values of a proximity sensor.

The graphs shown in FIG. 3 may indicate measurement values, which are measured by at least one of a gyro sensor, a magnetic field sensor, a gravity sensor, an orientation sensor, a rotation sensor, a vision sensor, a thermal sensor, and an optical sensor. The measurement values of each of the sensors mentioned above may have a unique variation (or change) pattern during a section starting from a point when the user's ear is placed near the mobile phone to a point when the user is viewing the display of the mobile phone, or during a section starting from a point when the user is viewing the display of the mobile phone to a point when the user's ear is placed near the mobile phone.

Additionally, the measurement values of each sensor may be combined with measurement values of other sensors. For example, the measurement value of a gyro sensor, the measurement value of a magnetic field sensor, and the measurement value of a thermal sensor may be combined, so as to be marked (or expressed) on the graph shown in FIG. 3.

According to the exemplary embodiments of the present invention, at least two threshold values 310 and 320 may be set up. More specifically, by comparing the measurement values of each of the other sensors or the combined values of the same with the threshold values 310 and 320, the exemplary embodiment of the present invention may determine whether the user's ear is positioned near the electronic device or whether the user is viewing the display of the electronic device. Moreover, the exemplary embodiment of the present invention may also determine whether or not a shift has occurred from any one of the situation having the user's ear positioned near the electronic device or the situation having the user view the display of the electronic device to another situation.

The above-described threshold values may be changed in accordance with user settings or settings made by the manufacturer. For example, if the user wishes to have the electronic device more sensitively determine whether the user's ear is positioned near the electronic device or whether the user is viewing the display of the electronic device, the at least two threshold values 310 and 320 may be set up to have lower absolute values.

Additionally, the exemplary embodiment of the present invention may determine whether or not a shift has occurred from any one of the situations having the user's ear positioned near the electronic device or having the user view the display of the electronic device to another situation, based upon a variation rate of the measurement values of each of the other sensors or the combined values of the same. Herein, knowledge on the variation change (or change rate) may be established by repeated experiments carried out by the manufacturer or by an automatic learning performed by the electronic device. And, based upon such knowledge, the corresponding variation rate may be used for determining the current status of the electronic device.

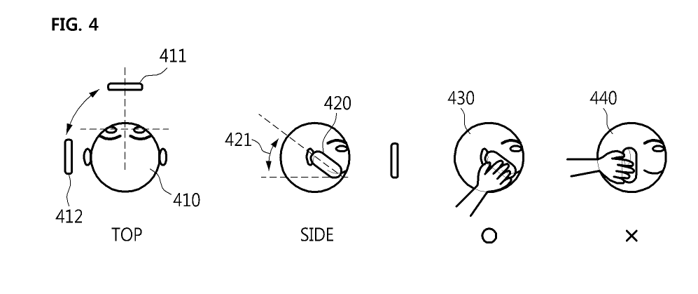

FIG. 4 illustrates a case when the user's ear is contiguous to (or placed near) the mobile phone or a case when the user is viewing a display of the mobile phone.

Referring to FIG. 4, when seen from a top view, the eyes of the user 410 are facing a 12 o'clock position. And, the ears of the user 410 are respectively facing a 3 o'clock position and a 9 o'clock position. As shown in FIG. 4, in case the user 410 is viewing the display of the electronic device 410, a straight line connecting the eyes of the user may be parallel to an x-axis or y-axis of the mobile phone (or electronic device), and, in case the electronic device 412 is placed near the ear of the user 410, the straight line connecting the eyes of the user may be perpendicular to the x-axis or y-axis of the mobile phone (or electronic device). Therefore, in case the user 410 is viewing the display of the mobile phone 411, and, then, when the user places the mobile phone 412 near his (or her) ear, the mobile phone 411 is rotated by approximately 90 degrees (90°) with respect to the y-axis. Additionally, in case the user 410 is viewing the display of the mobile phone 411, and, then, when the user places the mobile phone 412 near his (or her) ear, the mobile phone 411 may also be rotated by approximately 90 degrees (90°) with respect to the x-axis. Moreover, the rotation movements may similarly occur even when the user 410 is placing the mobile phone 412 near his (or her) ear and, then, when the user 410 views the display of the mobile phone 411. Due to such rotation or movement of the mobile phone, a unique change in the measurement values, which are measured by sensors (e.g., the gyro sensor, the magnetic field sensor, the rotation sensor, and so on) other than the proximity sensor, may occur in accordance with a specific variation (or change) pattern.

By learning in advance the variation pattern of the measurement values measured by other sensors, due to the rotation or movement of the mobile phone, the exemplary embodiments of the present invention may be capable of determining whether the user is viewing the mobile phone or whether the user is placing the mobile phone near his (or her) ear.

Additionally, when seen from a side view, since the eyes of the user 420 are located relatively higher than the ears of the user 420, the eyes and ears of the user 420 are spaced apart from one another at a specific distance along the horizontal direction. In case the mobile phone is placed near the ear of the user 420, generally, the user 420 places an upper portion of the mobile phone closer to his (or her) ear in order to be capable of clearly hearing audio output being outputted from the mobile phone, and the user 420 places a lower portion of the mobile phone closer to his (or her) mouth. When considering such situation, in case the user 420 places the mobile phone near his (or her) ear after (or while) viewing the display screen of the mobile phone, the mobile phone rotates by a specific angle 421 with respect to the z-axis. Even in a case when the user 420 moves the mobile phone in front of his (or her) face after (or while) placing the mobile phone near his (or her) ear, the rotation occurs in a similar manner. When closely observing this effect, when a shift has occurred from any one of the situation having the user's ear positioned near the electronic device or the situation having the user view the display of the electronic device to another situation, a change may occur in accordance with a specific variation pattern of the measurement values measured not only from the proximity sensor but also from other sensors. And, the exemplary embodiments of the present invention may use such specific variation pattern.

Additionally, in case the user 430 wishes to make a phone call, it will be apparent that tilting the mobile phone along the z-axis is more natural, and it will also be apparent that the user 440 may experience awkwardness when the mobile phone is not tilted along the z-axis.

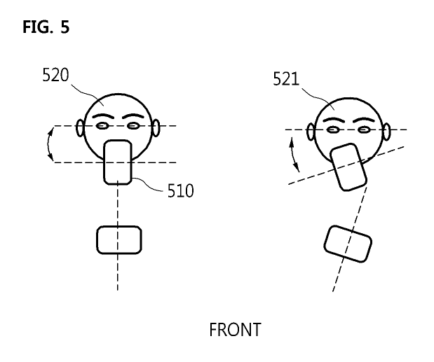

FIG. 5 illustrates two different cases when the user can view the mobile phone.

Referring to FIG. 5, in order to allow the user 520 and 521 to view the display of the mobile phone 510, the position of the mobile phone 510 should be shifted so that the straight line connecting the user's eyes can be parallel to the x-axis or the y-axis of the mobile phone 510. Additionally, this principle (or fact) is equally applied to a case when the user 521 is making or receiving a phone call, or to a case when the user views the display of the mobile phone 510 in order to push a ‘Call’ button or to verify a caller of the phone call.

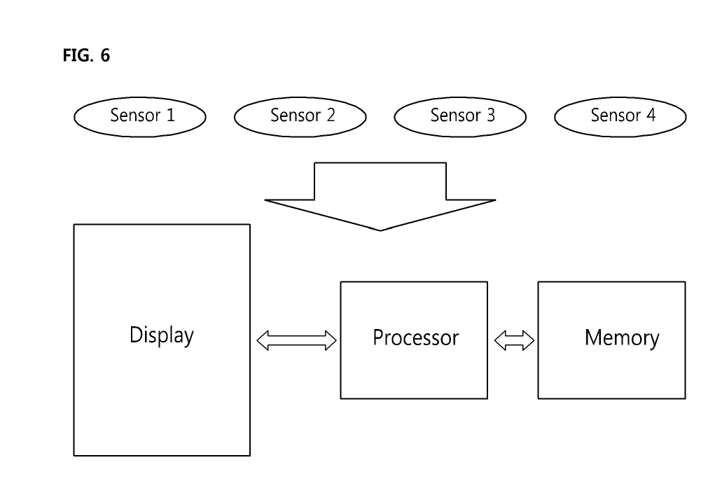

FIG. 6 illustrates a block view showing an electronic device according to an exemplary embodiment of the present invention.

Referring to FIG. 6, the electronic device according to the exemplary embodiment of the present invention includes a plurality of sensors each being differentiated from the proximity sensor, a display, a processor, and a memory.

When a shift occurs from any one of the situation having the user's ear positioned near the electronic device or the situation having the user view the display of the electronic device to another situation, as described above, the memory may store a variation pattern respective to the measurement values of the sensors. Such variation pattern may be predicted and learned based upon the physical characteristics and behavioral characteristics of the user. Evidently, instead of storing the variation pattern, the memory may store threshold values deduced from the variation pattern or threshold values set up by the user or the manufacturer.

The processor uses the measurement values measured by each of the sensors so as to detect the movement of the electronic device. Then, the processor responds to the detection of the movement of the electronic device, so as to determine whether the electronic device is placed near the user or whether the user is viewing the display of the electronic device by using the measurement values. The processor may also determine whether a shift has occurred from any one of the situation having the user's ear positioned near the electronic device or the situation having the user view the display of the electronic device to another situation.

Additionally, the processor may perform the above-described determining process only when the electronic device is in a state of carrying out (i.e., making or receiving) a phone call.

If a situation having the ear of the user placed near the mobile phone is shifted to a situation having the user view the mobile phone, the processor may shift the state of the display from an Off state to an On state, and the processor may increase the power being supplied to the display. Moreover, a touch sensor of the display may also be shifted from a deactivated state to an activated state, and diverse options, such as a soft keypad, a phone book, volume control, display control, and so on, may be provided to the user. Conversely, if a situation having the user view the mobile phone is shifted to a situation having the ear of the user placed near the mobile phone, the processor may shift the state of the display from an On state to an Off state, and the processor may decrease (or reduce) the power being supplied to the display. Moreover, a touch sensor of the display may also be shifted from an activated state to a deactivated state.

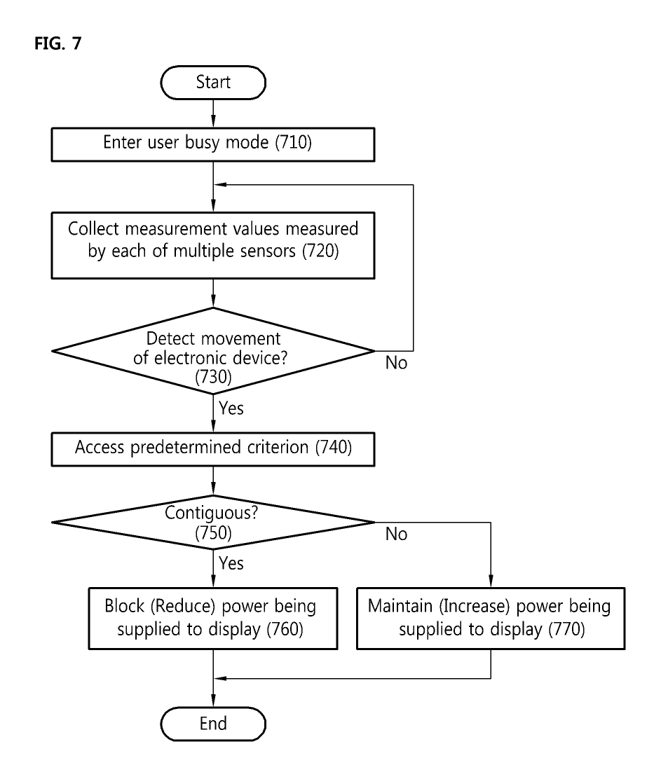

FIG. 7 illustrates a flow chart showing a method according to an exemplary embodiment of the present invention.

Referring to FIG. 7, in the method according to the exemplary embodiment of the present invention, in case the user is making a phone call or receiving a phone call, the electronic device enters a user busy mode (710). In response to such entry, an algorithm using other sensors without having to use a proximity sensor is executed.

At this point, the method uses each of the sensors being differentiated from the proximity sensor, so as to collect measurement values measured by each of the sensors (720).

At this point, based upon the measurement values measured by each of the sensors, the method determines whether or not a movement of the electronic device is detected (730). In case no movement of the electronic device is detected, step 720 is performed once again, and, in case a movement of the electronic device is detected, step 740 is executed.

More specifically, the method accesses the memory in order to verify which predetermined criterion is being used (740). For example, the method may verify which threshold values are being compared with the measurement values measured by each sensor.

When such predetermined criterion is verified, the method uses the measurement values measured by each of the sensors in accordance with the verified criterion, so as to determine whether or not the ear of the user is placed near the electronic device (750). Evidently, in step 750, in addition to determining whether or not the ear of the user is placed near the electronic device, the method may also determine whether or not the user is viewing the display of the electronic device. For example, if each of the measurement values measured by each sensor or a combination of the measurement values is greater than the threshold value for a predetermined period of time, it may be determined that the electronic device is placed near the ear of the user. Evidently, such examples merely correspond to exemplary embodiments of the present invention, and, therefore, such examples may be diversely varied by anyone skilled in the art.

As described above, the method and apparatus for determining whether an ear of a user is contiguous to an electronic device or whether a user watches a display of the electronic device have the following advantages. According to an exemplary embodiment of the present invention, by providing the main functions of the proximity sensor without the actual proximity sensor, the fabrication cost of the mobile phone, the size of the mobile phone, repair and replacement costs may be reduced. According to another exemplary embodiment of the present invention, by using measurement values of other sensors, the main functions of the proximity sensor may be provided without the actual proximity sensor.

The above-described device according to the exemplary embodiment of the present invention may be realized in the form of a hardware component, a software component, and/or a combination of a hardware component and a software component. For example, the device and corresponding components according to the above-described exemplary embodiments of the present invention may be realized by using at least one or more universal computers or special-purpose computers, such as a processor, a controller, an arithmetic logic unit (ALU), a digital signal processor, a field programmable array (FPA), a programmable logic unit (PLU), a microprocessor, or any type of device that can execute and respond to an instruction (or command). A processing device may execute an operating system (OS) and at least one or more software application, which is executed within the operating system (OS). Additionally, the processing device may respond to the execution of a software application, so as to access, store, manipulate, process, and generate data. In order to facilitate and simplify the understanding of the present invention, the present invention may be described to include only one processing device. However, it will be apparent to anyone skilled in the art that the processing device may include a plurality of processing elements and/or may include multiple types of processing elements. For example, the processing device may include multiple processors, or the processing device may include one processor and one controller. Additionally, other processing configuration, such as a parallel processor, may be configured herein.

The software may include a computer program, a code, an instruction, or a combination of one or more of the above. And, the software may configure a processing device, so that the processing device can be operated as intended, or the software may independently or collectively instruct (or command) the processing device. In order to be interpreted by the processing device, or in order to provide an instruction or data to the processing device, the software and/or data may be permanently or temporarily embodied in any type of machine, a component, a physical equipment (or device), a virtual equipment, a computer storage medium or device, or a transmitted signal wave. Since the software is dispersed (or scattered) within a computer system being connected to a network, the software may be stored or executed by using in a dispersion method. The software and data may be stored in one or more computer-readable recording media.

The method according to the exemplary embodiment of the present invention may be realized in a program command (or instruction) format that may be executed by using diverse computing means, so as to be recorded in a computer-readable medium. Herein, the computer-readable medium may independently include a program command (or instruction), a data file, a data structure, and so on, or may include a combination of the same. The program command being recorded in the medium may correspond to a program command that is specifically designed and configured for the exemplary embodiments of the present invention, or the program command may correspond to a program command that is disclosed and available to anyone skilled in or related to computer software. Examples of the computer-readable recording medium may include magnetic media, such as hard discs, floppy discs, and magnetic tapes, optical media, such as CD-ROMs, DVDs, and so on, magneto-optical media, such as floptical discs, and hardware devices specially configured (or designed) for storing and executing program commands, such as ROMs, RAMs, flash memories, and so on. Examples of a program command may not only include machine language codes, which are created by a compiler, but may also include high-level language codes, which may be executed by a computer by using an interpreter, and so on. The above-mentioned hardware equipment may be configured to be operated as one or more software modules for executing the operations of the exemplary embodiment of the present invention, and vice versa.

It will be apparent to those skilled in the art that various modifications and variations can be made in the present invention without departing from the spirit or scope of the inventions. For example, the above-described techniques may be executed in an order different from that described in the description of the present invention, and/or the components of the above-described system, structure, equipment (or device), circuit, and so on, may be combined in a format different that of the above-described method according to the present invention, and an adequate result may be achieved even if the above-described components of the present invention are replaced by any other component or its equivalent.

Thus, it is intended that the present invention covers other realizations and other embodiments of this invention provided they come within the scope of the appended claims and their equivalents.

What is claimed is:

1. A method for determining a proximity level between an electronic device and a user, comprising the steps of:
acquiring a measurement value from at least one sensor being differentiated from a proximity sensor;
detecting a movement of the electronic device by using the measurement value;
responding to the detection of the electronic device and determining whether or not the electronic device is placed near (or contiguous to) the user or whether or not the user is viewing a display of the electronic device by using the measurement value; and
controlling the electronic device based upon the determined result.

2. The method of claim 1, wherein the step of controlling the electronic device comprises:
checking whether or not the electronic device is in a user busy mode; and
in case the electronic device is in the user busy mode, controlling power being supplied to a display of the electronic device based upon the determined result.

3. The method of claim 1, wherein the step of determining whether or not the electronic device is placed near the user corresponds to a step of determining whether or not the electronic device is placed near the user or whether or not the user is viewing the display of the electronic device based upon a variation pattern of the measurement values.

4. The method of claim 3, wherein the step of determining whether or not the electronic device is placed near the user comprises:
comparing a value indicating a variation pattern of the measurement values with a predetermined threshold value.

5. The method of claim 1, wherein the step of determining whether or not the electronic device is placed near the user corresponds to a step of determining whether or not the electronic device is placed near the user or whether or not the user is viewing the display of the electronic device by using measurement values measured by at least two or more sensors, each being differentiated from the proximity sensor and each being different from one another.

6. The method of claim 2, wherein, in the step of controlling power being supplied to a display of the electronic device, when it is determined that the electronic device is placed near the user, the power being supplied to the display is reduced or blocked, and, when it is determined that the electronic device is not placed near the user, the power being supplied to the display is maintained or increased.

7. The method of claim 1, wherein the at least one sensor includes at least one of a gyro sensor, a magnetic field sensor, a gravity sensor, an orientation sensor, a rotation sensor, a vision sensor, a thermal sensor, a microphone, an optical sensor, and a touch sensor.

8. A computer-readable recording medium having a program for executing the method of claim 1 recorded therein.

9. An electronic device, comprising:
a display configured to display an image signal;
at least one sensor configured to be differentiated from a proximity sensor and to generate measurement values from a position, alignment or movement of the electronic device; and
a processor configured to detect a movement of the electronic device by using the measurement value, to respond to the detection of the electronic device and to determine whether or not the electronic device is placed near the user or whether or not the user is viewing a display of the electronic device by using the measurement value, and to control the electronic device based upon the determined result.

10. The electronic device of claim 9, wherein the processor checks whether or not the electronic device is in a user busy mode, and wherein, in case the electronic device is in the user busy mode, the processor controls power being supplied to a display of the electronic device based upon the determined result.

11. The electronic device of claim 9, wherein the processor determines whether or not the electronic device is placed near the user based upon a variation pattern of the measurement values.

12. The electronic device of claim 11, wherein the processor compares a value indicating a variation pattern of the measurement values with a predetermined threshold value.

13. The electronic device of claim 9, wherein the processor determines whether or not the electronic device is placed near the user or whether or not the user is viewing the display of the electronic device by using measurement values measured by at least two or more sensors, each being differentiated from the proximity sensor and each being different from one another.

14. The electronic device of claim 9, wherein, when it is determined that the electronic device is placed near the user, the processor reduces or blocks the power being supplied to the display, and wherein, when it is determined that the electronic device is not placed near the user, the processor maintains or increases the power being supplied to the display.

15. The electronic device of claim 9, wherein the at least one sensor includes at least one of a gyro sensor, a magnetic field sensor, a gravity sensor, an orientation sensor, a rotation sensor, a vision sensor, a thermal sensor, a microphone, an optical sensor, and a touch sensor.
